(19) United States
(12) Patent Application Publication
(10) Pub. No.: US 2023/0287852 A1
(43) Pub. Date: Sep. 14, 2023

(54) COMPONENT FOR AN INJECTION SYSTEM, AND INJECTION SYSTEM FOR MIXTURE-COMPRESSING, SPARK-IGNITION INTERNAL COMBUSTION ENGINES, AS WELL AS METHOD FOR MANUFACTURING SUCH A COMPONENT

(71) Applicant: Robert Bosch GmbH, Stuttgart (DE)

(72) Inventors: Florian Grenz, Schwalbach (DE); Ingo Rettig, Schwieberdingen (DE)

(21) Appl. No.: 18/005,991

(22) PCT Filed: May 26, 2021
(86) PCT No.: PCT/EP2021/064030

§ 371 Date: Jan. 19, 2023

(30) Foreign Application Priority Data
Jul. 14, 2020 (DE) 10 2020 208 759.8

(51) Int. Cl. F02M 55/02; F02M 61/14; F02M 61/16

(52) U.S. Cl. CPC F02M 55/025; F02M 61/14; F02M 61/168; F02M 2200/8023; F02M 2200/852; F02M 2200/853; F02M 2200/856

(57) ABSTRACT

A component for an injection system. The component includes a base body and at least one connecting piece, which is formed at the base body and used to connect an injector. The injector, during assembly, being insertable along a mounting axis into an accommodating space of the connecting piece. The base body and the connecting piece are formed by a forging operation. A recess is formed at an outer side of the connecting piece, in which, in the mounted state, an orienting element of the injector engages for restricting a rotational degree of freedom of the injector about the mounting axis. The connecting piece is post-processed after the forging so that a lateral surface of the recess is at least approximately configured with a predefined lateral height.

### FIELD

The present invention relates to a component, in particular, a fuel distributor, for an injection system which is used for mixture-compressing, spark ignition internal combustion engines. Specifically, the present invention relates to the field of injection systems of motor vehicles, in which a direct injection of fuel into combustion chambers of an internal combustion engine takes place.

### BACKGROUND INFORMATION

A fuel distributor including a pressure accumulator pipe is described in German Patent Application No. DE 10 2018 110 342 A1, the pressure accumulator pipe including a forged base body. Flange pieces are provided at the base body, which are formed in one piece of a single material at the base body by forging and provided with mounting openings.

### SUMMARY

A component according to the present invention, an injection system according to the present invention, and a method according to the present invention have the advantage that an improved design and functionality are made possible.

The measures disclosed herein allow advantageous refinements of the component, of the injection system, and of the method, of the present invention.

The injection system according to the present invention is used for mixture-compressing, spark ignition internal combustion engines. The injection system according to the present invention is used for injecting gasoline and/or ethanol and/or comparable fuels and/or for injecting a mixture including gasoline and/or ethanol and/or comparable fuels. The mixture may, for example, be a mixture including water. The component according to the present invention is used for such injection systems.

According to an example embodiment of the present invention, at least the base body of the component is formed of a material which is preferably a stainless steel, in particular, an austenitic stainless steel. In particular, the material may be based on an austenitic stainless steel having the material number 1.4301 or 1.4307 or on a stainless steel comparable thereto. Specifically, austenitic steels having the material numbers 1.4301, 1.4306, 1.4307, and 1.4404 may be used. Hydraulic terminals provided at the base body may each be designed as a high pressure input, a high pressure output, or another high pressure terminal. The base body is then preferably configured as a forging blank, together with a high pressure input, at least one high pressure output, which is implemented at the connecting piece, and possibly one or multiple other high pressure terminals during the manufacture, and is further processed.

The configuration of a fuel distributor according to the present invention thus results in considerable differences compared to a soldered rail, in which a pipe for the soldered rail is machined and deburred before the attachment components are soldered on. Due to the forged embodiment, in particular, a design for higher pressures may be made possible. A considerable difference compared to a high pressure rail for compression ignition internal combustion engines is the material selection and the processing, in particular the forging of a stainless steel.

According to an example embodiment of the present invention, as a result of the described post-processing of the connecting piece, which takes place after forging, advantageously a consistent lateral height at connecting pieces of multiple components may be implemented. Specifically, an advantageous refinement according to the present invention may be implemented in the process. In particular, a lateral height may be predefined in such a way that at least a minimum height required for the function of the limitation of the rotational degree of freedom is implemented. The predefined lateral height may then possibly be uniformly implemented at multiple connecting pieces of a component. Within the scope of a series manufacture, the predefined lateral height, which is at least as great as a minimum height, may then be uniformly predefined over a large number of components. After the forging operation, fluctuations of the component size and thus, in particular, deviations between the geometries of the connecting pieces result, by virtue of tolerances, at the individual connecting pieces as well as at connecting pieces of different components. The post-processing after the forging is preferably carried out in such a way that consistent configurations of the lateral surfaces of the recess of the connecting piece are implemented. By a function-appropriate deburring, a simplified machining may be made possible in the described embodiment, with a reduced start-up, correction and measuring effort.

Variations of the geometry of the individual connecting pieces may advantageously take place in the process with the aid of an edge removal of variable size. This is, in particular, possible in an advantageous refinement of the present invention. In the process, the post-processing may be based on a functional and tolerance analysis to ensure the required function, and to cover the fluctuations of the component size present due to tolerances.

The geometry and/or size of the resulting edge may then vary as a function of the deviation of the outer contour of the component. Since the design criterion for the processing is to ensure required functional surfaces at the lateral surfaces, deviations of the geometries of the connecting pieces at a fluid distributor or between multiple fluid distributors during a series manufacture result in differing geometries of the implemented edges. In this way, a refinement according to an example embodiment of the present invention thus advantageously takes place. It is particularly advantageous when the at least one lateral surface and the edge are implemented by a single tool in one process step, as is possible according to the advantageous refinement according to present invention. In a modified embodiment, the lateral surfaces and the edge, however, may also each be processed using individual tools.

### BRIEF DESCRIPTION OF THE DRAWINGS

Preferred exemplary embodiments of the present invention are described in greater detail in the following description with reference to the figures, in which corresponding elements are provided with concurrent reference numerals.

FIG. 1 shows an injection system for a mixture-compressing, spark ignition internal combustion engine including a component designed as a fuel distributor in a schematic sectional representation corresponding to one exemplary embodiment of the present invention.

FIG. 2 shows the section of the component denoted by II in FIG. 1 corresponding to the exemplary embodiment in a detailed, schematic representation.

FIG. 3 shows a detail of a connecting piece of the component illustrated in FIG. 2 corresponding to the exemplary embodiment of the present invention.

FIG. 4 shows a section along the intersecting line, denoted by IV in FIG. 2, through a recess of a connecting piece in a comparison with another possible post-processing for explaining the exemplary embodiment of the present invention in a schematic representation.

FIG. 5A and FIG. 5B show schematic, excerpted representations of a connecting piece and of a further connecting piece of the component illustrated in FIG. 1 for explaining an example embodiment of the present invention.

### DETAILED DESCRIPTION OF EXAMPLE EMBODIMENTS

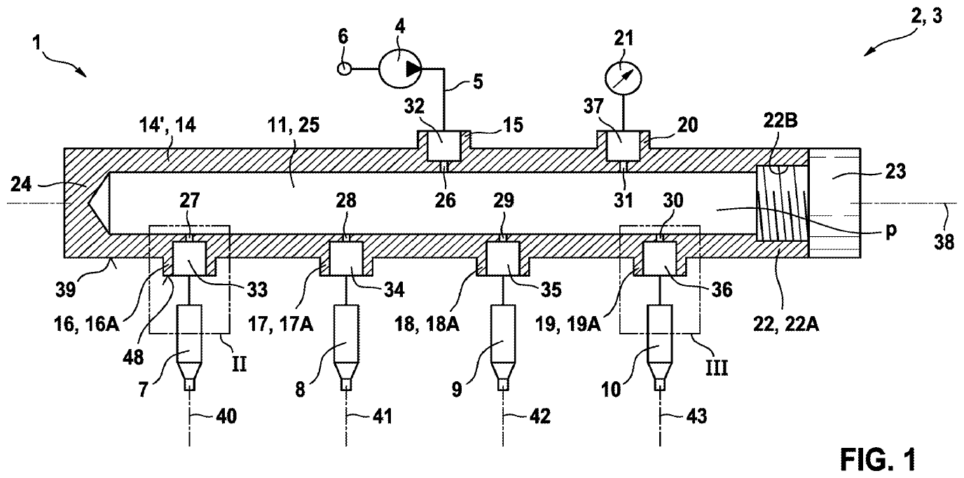

FIG. 1 shows an injection system 1 including a fuel distributor (fluid distributor) 2 in a schematic sectional representation corresponding to a first exemplary embodiment. In this exemplary embodiment, fuel distributor 2 of fuel injection system 1 is a component 3 designed corresponding to the present invention. Furthermore, a high pressure pump 4 is provided. High pressure pump 4 is connected via a fuel line 5 designed as a high pressure line 5 to fuel distributor 2. During operation, a fuel or a mixture including fuel is supplied as the fluid at an input 6 of high pressure pump 4.

Fuel distributor 2 is used for storing and distributing the fluid among injectors 7 through 10 designed as fuel injectors 7 through 10 and reduces pressure fluctuations and pulsations. Fuel distributor 2 may also be used for damping pressure pulsations, which may occur when switching fuel injectors 7 through 10. In the process, during operation, high pressures p may occur at least temporarily in an interior space 11 of component 3.

Fuel distributor 2 includes a tubular base body 14, which is formed by a one-stage or multi-stage forging process. Component 3 includes a tubular base body 14, a high pressure input 15, and multiple hydraulic terminals 16 through 19, which are provided at the tubular base body and designed as high pressure outputs 16 through 19. Furthermore, a pressure sensor terminal 20 is provided at tubular base body 14. In this exemplary embodiment, tubular base body 14, high pressure input 15, connecting pieces 16A through 19A for high pressure outputs 16 through 19, and pressure sensor terminal 20 are formed of a forged individual part 14′. High pressure input 15, connecting pieces 16A through 19A for high pressure outputs 16 through 19, and pressure sensor terminal 20 are thus forged to base body 14.

Fuel injectors 7 through 10 are in each case connected to high pressure outputs 16 through 19 of fuel distributor 2. Furthermore, a pressure sensor 21 is provided, which is connected to pressure sensor terminal 20. At one end 22, tubular base body 14 is closed by a closure 23 designed as a screw plug 23 in this exemplary embodiment. In the process, end 22 of tubular base body 14 may be designed as a threaded connecting piece 22A. In one modified embodiment, an axial high pressure input may be provided at end 22 or at an end 24, instead of radial high pressure input 15.

After forging, tubular base body 14 or forged individual part 14′ is processed by at least a machining operation. In this exemplary embodiment, a borehole 25 is also formed in tubular base body 14 after forging to form interior space 11. Via interior space 11, the fluid supplied at high pressure input 15 may be distributed during operation among fuel injectors 7 through 10 connected to high pressure outputs 16 through 19.

Moreover, boreholes 26 through 31 are introduced into forged individual part 14′ by a machining operation. In the process, boreholes 27 through 30 serve as connecting boreholes 27 through for high pressure outputs 16 through 19. Borehole 26 is used for high pressure input 15. Borehole 31 is used for pressure sensor terminal 20. Furthermore, an internal thread 22B is cut into borehole 25 at end 22 of base body 14, so that threaded connecting piece 22A is formed.

Moreover, boreholes 32 through 37 may be provided at high pressure input 15, connecting pieces 16A through 19A of high pressure outputs 16 through 19, and pressure sensor terminal 20. In this exemplary embodiment, borehole 25 is axially oriented with respect to a longitudinal axis 38. Boreholes 32 through 37 are radially oriented with respect to longitudinal axis 38 in this exemplary embodiment. An outer side 39 of base body 14 may be based on a cylindrical jacket-shaped basic shape.

In the schematic representation of FIG. 1, boreholes 33 through 36 are radially oriented with respect to longitudinal axis 38. In possible embodiments of the present invention, boreholes 33 through 36 are preferably radially or radially-eccentrically oriented with respect to longitudinal axis 38. As a result of boreholes 33 through 36 of connecting pieces 16A through 19A, mounting axes 40 through 43 for injectors 7 through are then predefined. Mounting axes 40 through 43 are then radially or radially-eccentrically oriented with respect to longitudinal axis 38.

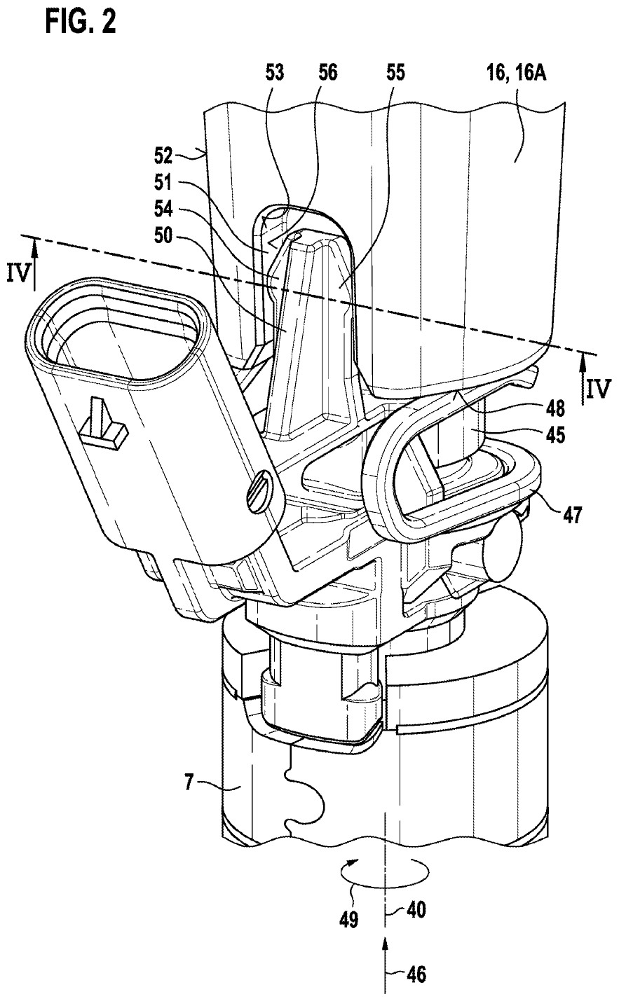

FIG. 2 shows the section of component 3 denoted by II in FIG. 1 corresponding to the exemplary embodiment in a detailed, schematic representation. In the process, injector 7 and connecting piece 16A of high pressure output 16 are selected by way of example for injectors 7 through 10 and connecting pieces 16A through 19A of high pressure outputs 16 through 19. Injector 7 includes an inlet nozzle 45 which, during assembly, is inserted in a mounting direction 46 along mounting axis 40 into borehole 33 (FIG. 1) of connecting piece 16A. In the process, injector 7, in the mounted state, is held by a hold-down device 47, which is braced on an underside 48 of connecting piece 16A, against a cylinder head, which is not shown, counter to mounting direction 46. In this way, injector 7 is positioned and held along mounting axis 40. In principle, additionally there are also degrees of freedom, namely rotational degrees of freedom, in and counter to an (arbitrarily) selected direction of rotation 49. These rotational degrees of freedom are also restricted in the mounted state. For this purpose, an orienting element 50 of injector 7 engages in a recess 51 of connecting piece 16A, which is provided at an outer side 52 of connecting piece 16A. In the process, recess 51 transitions at an edge 53 into outer side 52. Furthermore, recess 51 is open toward underside 48 of connecting piece 16A so that, during assembly, orienting element 50 may be inserted in mounting direction 46, coaxially with respect to mounting axis 40, into recess 51 of connecting piece 16A. To reduce, or entirely avoid, a play in direction of rotation 49, which is possible in principle, lateral noses 54, 55 are formed at orienting element 50 in this exemplary embodiment.

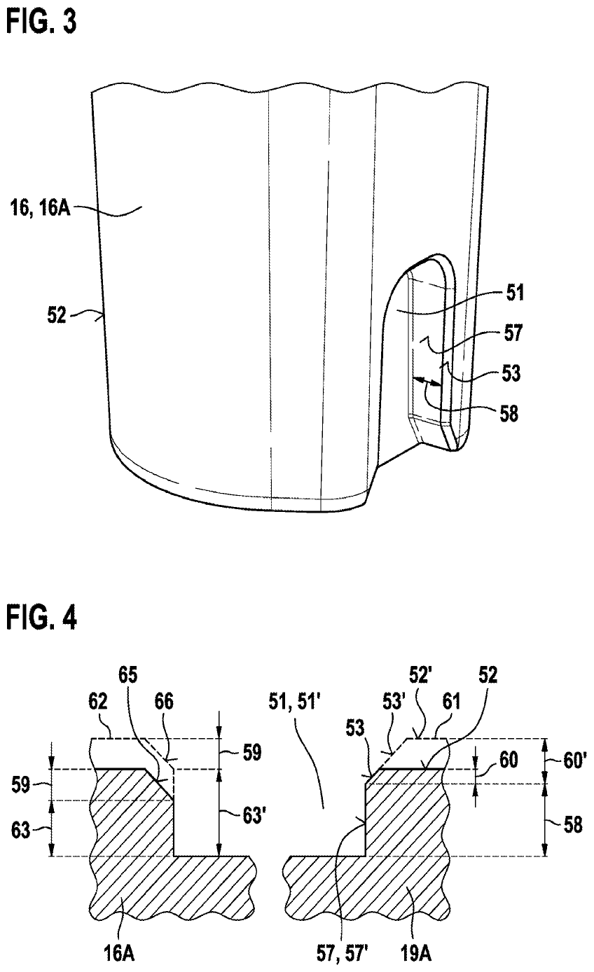

The design of component 3 and the operating mode in the exemplary embodiment of the present invention are also further described hereafter with reference to FIGS. 3, 4 as well as 5A and 5B. FIG. 3 shows a detail of connecting piece 16A of component 3 illustrated in FIG. 2 corresponding to the exemplary embodiment. FIG. 4 shows a section along the intersecting line, denoted by IV in FIG. 2, through recess 51 of connecting piece 16A (right side) in a comparison with another possible post-processing (left side) for explaining the exemplary embodiment of the present invention in a schematic representation.

A first lateral surface 56 and a second lateral surface 57 are provided at recess 51. In the process, a contact occurs between nose 54 and first lateral surface 46 for restricting the rotational degree of freedom of injector 7 relative to component 3 in direction of rotation 49. Correspondingly, a contact occurs between nose 55 and second lateral surface 57 for restricting the rotational degree of freedom counter to direction of rotation 49. In the process, a predefined lateral height 58, which is schematically drawn in FIG. 3, is required to enable a reliable contact between noses 54, 55 and lateral surfaces 56, 57. Proceeding from recess 51 shown in FIG. 3, a processing of edge 53 occurs such as is illustrated in FIG. 4.

The right side of FIG. 4 shows the processing of edge 53 carried out corresponding to one possible embodiment of the present invention. In the process, edge 53 is processed in such a way that lateral height 58 is at least ensured at first lateral surface 56 and at second lateral surface 57. On the left side of FIG. 4, in contrast, a situation is shown in which a certain edge height 59 is being implemented, which does not correspond to the present invention.

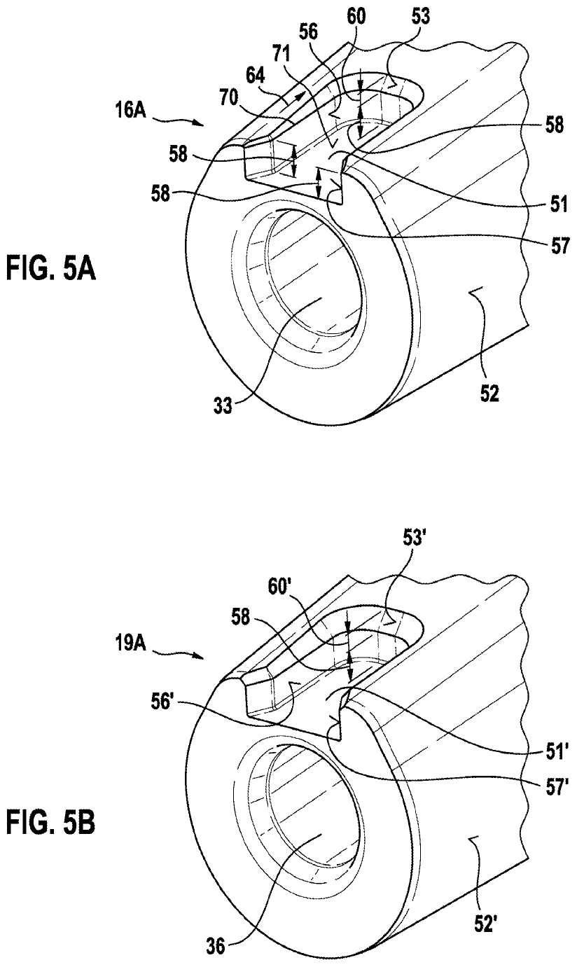

FIG. 5A shows a schematic, excerpted representation of connecting piece 16A of the component shown in FIG. 1 for explaining one possible embodiment of the present invention, as it may be provided in the section denoted by II. Since predefined lateral height 58 is implemented both at first lateral surface 56 and at second lateral surface 57, a variable edge height 60 results along the extension of edge 53.

FIG. 5B shows a schematic, excerpted representation of connecting piece 19A, which is selected as a further connecting piece 19A by way of example here, of the component shown in FIG. 1 in the section denoted by III for explaining one possible embodiment of the present invention. For example, during the manufacture, in particular, the forging, a tolerance-induced deviation may occur, in which more material is provided at connecting piece 19A than at connecting piece 16A. This situation is illustrated in FIG. 4 on the right side with the aid of a broken line 61. For comparison, a situation including more material is also illustrated, on the left side of FIG. 4, by a broken line 62, the achieved result, however, not corresponding to the present invention. A recess 51′, which at an edge 53′ transitions into outer side 52′, is provided at outer side 52′ of connecting piece 19A. A first lateral surface 56′ and a second lateral surface 57′ are, in turn, implemented with predefined lateral height 58. This results in a variable edge height 60′. Since predefined lateral height 58 is implemented as the target variable, edge 53′ at connecting piece 19A differs from edge 53 at connecting piece 16A. In particular, variable edge heights 60, 60′ along the extensions of edges 53, 53′ differ from one another (at corresponding locations).

As is illustrated on the left side of FIG. 4, the situation that lateral heights 63, 63′ differ from one another arises when a certain edge height 59 is predefined. Furthermore, upon consideration of FIG. 5A, for example, it becomes apparent that predefining a certain edge height 59 along a profile of the edge, for example in a direction 64, would result in an increasing lateral height along direction 64.

In this way, the consequence of the measure illustrated on the left side of FIG. 4 of predefining a certain edge height 59 would be that both the lateral height of the lateral surfaces at an individual connecting piece would be variable, for example along direction 64, and also differences with respect to the lateral height between different connecting pieces would occur.

In one possible embodiment of the present invention, for example, the predefined lateral height 58 would be at least approximately equal to the minimum height for lateral surfaces 56, 57. As is illustrated on the left side in FIG. 4, in contrast in an embodiment which does not correspond to the present invention, in particular, during a post-processing of an edge 65, 66, it is possible for one case to occur that the resulting lateral height 63 considerably falls short of the minimum height, while in another case the minimum height is considerably exceeded by lateral height 63′. Such an undershoot and exceedance could possibly also occur along direction 64 at the lateral surfaces of an individual connecting piece.

In this way, the described post-processing may ensure the function of recess 51 at connecting piece 16A since lateral surfaces 56, 57 serving as lateral stop surfaces are always present in sufficient height. The processing of edge 53 or a deburring may then be defined in such a way, taking the fluctuations of the outer geometry of connecting piece 16A as well as the manufacturing tolerances into consideration, that the minimally required lateral height is present at all times. The resultant variable size, in particular, edge height 60, of the processed edge 53 has no influence on the function.

The post-processing of edge 53 may take place at a suitable tool angle. Edge 53 may also have a different edge geometry. For example, edge 53 may also be implemented as a rounded edge 53.

In the described embodiment, an inner edge line 70, which runs, amongst others, between first lateral surface 56 or second lateral surface 57 and edge 53, may then be continuously spaced apart from a base 71 of recess 51 corresponding to the certain lateral height 58.

In this way, connecting piece 16A is post-processed after forging in such a way that at least one lateral surface 56, 57 of recess 51 of connecting piece 16A, at which, in the mounted state, a contact is made possible between orienting element 50 of injector 7 and connecting piece 16A, is configured with a predefined lateral height 58. This applies correspondingly to other connecting pieces 16A through 19A.

The present invention is not restricted to the described exemplary embodiments.

1-10. (canceled)

11. A component for an injection system for a mixture-compressing, spark ignition internal combustion engine, which is used for metering a highly pressurized fluid, the component comprising:
a base body; and
at least one connecting piece, which is formed at the base body and is configured to connect an injector, the injector, during assembly being insertable along a mounting axis into an accommodating space of the connecting piece, at least the base body and the connecting piece being formed by a one-stage or multi-stage forging operation, and a recess being formed at an outer side of the connecting piece, in which, in the mounted state, an orienting element of the injector engages for restricting a rotational degree of freedom of the injector about the mounting axis, wherein the connecting piece is post-processed after the forging in such a way that at least one lateral surface of the recess of the connecting piece, at which, in the mounted state, a contact between the orienting element of the injector and the connecting piece is made possible for restricting the rotational degree of freedom in a selected direction of rotation about the mounting axis, is at least approximately configured with a predefined lateral height.

12. The component as recited in claim 11, wherein the component is a fluid distributor.

13. The component as recited in claim 11, wherein a further lateral surface of the recess of the connecting piece, which faces the lateral surface of the recess and at which, in the mounted state, the contact between the orienting element of the injector and the connecting piece is made possible for restricting the rotational degree of freedom counter to the selected direction of rotation, is at least approximately configured with the predefined lateral height.

14. The component as recited in claim 13, wherein the recess transitions at an edge into the outer side of the connecting piece, the edge is configured as a processed edge, and the processing of the edge is carried out in such a way that the lateral surface and/or the further lateral surface, is at least approximately configured with the predefined lateral height.

15. The component as recited in claim 14, wherein the processed edge is an at least partially beveled and/or at least partially rounded edge.

16. The component as recited in claim 14, wherein the processed edge is configured with an at least partially varying edge geometry, including an at least partially varying edge height, along an edge profile.

17. The component as recited in claim 16, wherein the post-processing of the connecting piece after the forging is configured in such a way that the edge geometry including the edge height, is modified during the post-processing in such a way that the lateral surface and/or the further lateral surface is at least approximately configured with the predefined lateral height.

18. The component as recited in claim 14, wherein the connecting piece is post-processed after the forging in such a way that the recess and the edge together are configured with a combined tool geometry.

19. The component as recited in claim 11, further comprising:
at least one further connecting piece used for connecting a further injector, the further injector during assembly being insertable along a further mounting axis into an accommodating space of the further connecting piece, at least the base body, the connecting piece, and the further connecting piece being formed by the one-stage or multi-stage forging operation, and a recess being formed at an outer side of the further connecting piece, in which, in the mounted state, an orienting element of the further injector engages for restricting a rotational degree of freedom of the further injector about the further mounting axis, and the further connecting piece is post-processed after the forging in such a way that at least one lateral surface of the recess of the further connecting piece, at which, in the mounted state, a contact between the orienting element of the further injector and the further connecting piece is made possible for restricting the rotational degree of freedom in a selected direction of rotation about the further mounting axis, is at least approximately configured with a predefined lateral height.

20. An injection system for a mixture-compressing, spark ignition internal combustion engine, which is used for injecting a fluid which is fuel, the fuel including gasoline and/or ethanol and/or a mixture including fuel, the injection system comprising:
a component used for metering the fluid, the component including:
a base body; and
at least one connecting piece, which is formed at the base body and is configured to connect an injector, the injector, during assembly being insertable along a mounting axis into an accommodating space of the connecting piece, at least the base body and the connecting piece being formed by a one-stage or multi-stage forging operation, and a recess being formed at an outer side of the connecting piece, in which, in the mounted state, an orienting element of the injector engages for restricting a rotational degree of freedom of the injector about the mounting axis, wherein the connecting piece is post-processed after the forging in such a way that at least one lateral surface of the recess of the connecting piece, at which, in the mounted state, a contact between the orienting element of the injector and the connecting piece is made possible for restricting the rotational degree of freedom in a selected direction of rotation about the mounting axis, is at least approximately configured with a predefined lateral height.

21. A method for manufacturing a component for an injection system for a mixture-compressing, spark ignition internal combustion engine, which is used for metering a highly pressurized fluid, the component including:
a base body, and
at least one connecting piece, which is formed at the base body and is configured to connect an injector, the injector, during assembly being insertable along a mounting axis into an accommodating space of the connecting piece, at least the base body and the connecting piece being formed by a one-stage or multi-stage forging operation, and a recess being formed at an outer side of the connecting piece, in which, in the mounted state, an orienting element of the injector engages for restricting a rotational degree of freedom of the injector about the mounting axis,
the method comprising:
postprocessing the connecting piece after the forging in such a way that at least one lateral surface of the recess of the connecting piece, at which, in the mounted state, a contact between the orienting element of the injector and the connecting piece is made possible for restricting the rotational degree of freedom in a selected direction of rotation about the mounting axis, is at least approximately configured with a predefined lateral height.
